(19) United States
(12) Patent Application Publication
(10) Pub. No.: US 2012/0232222 A1
(43) Pub. Date: Sep. 13, 2012

(54) METHOD FOR PRODUCING 1-ALKOXY-2-METHYL-1-OXOPROPAN-2-YL (METH)ACRYLATE

(75) Inventors: Thorben Schütz, Seeheim-Jugenheim (DE); Joachim Knebel, Alsbach-Haehnlein (DE); Guenther Graeff, Alsbach-Haehnlein (DE); Ruediger Carloff, Darmstadt (DE); Roger Recktenwald, Bensheim (DE); Volker Herzog, Darmstadt (DE)

(73) Assignee: Evonik Roehm GmbH, Darmstadt (DE)

(21) Appl. No.: 13/497,631

(22) PCT Filed: Sep. 7, 2010
(86) PCT No.: PCT/EP10/63066

§ 371 Date: Mar. 22, 2012

(30) Foreign Application Priority Data
Oct. 30, 2009 (DE) 10 2009 046 194.9

(51) Int. Cl. C08F 8/14

(52) U.S. Cl. 525/330.6

(57) ABSTRACT

The invention provides a process for preparing 1-alkoxy-2-methyl-1-oxopropan-2-yl(meth)acrylate, e.g. 1-methoxy-2-methyl-1-oxopropan-2-yl(meth)acrylate, by transesterifying alkyl α-hydroxyisobutyrates. Copolymerization of such monomers in the preparation of poly(meth)acrylate-based moulding materials improves the heat distortion resistance thereof.

### FIELD OF THE INVENTION

The invention provides a process for preparing 1-alkoxy-2-methyl-1-oxopropan-2-yl(meth)acrylate, e.g. 1-methoxy-2-methyl-1-oxopropan-2-yl(meth)acrylate, by transesterifying alkyl α-hydroxyisobutyrates. Copolymerization of such monomers in the preparation of poly(meth)acrylate-based moulding materials improves the heat distortion resistance thereof.

(Meth)acrylates or poly(meth)acrylates are understood hereinafter to mean derivatives of acrylic acid, of methacrylic acid and mixtures of the above, or polymers thereof. For the term 1-alkoxy-2-methyl-1-oxopropan-2-yl(meth)acrylate, alkyl(meth)acryloylisobutyrate or α-hydroxyisobutyric acid alkyl ester(meth)acrylate, or the abbreviation HIBA-(M)A, is also used synonymously hereinafter. The same applies to specific compounds. More particularly, for 1-methoxy-2-methyl-1-oxopropan-2-yl methacrylate, methyl methacryloylisobutyrate or α-hydroxyisobutyric acid methyl ester methacrylate, or the abbreviation HIBM-MA, is used synonymously hereinafter.

### STATE OF THE ART

In JP 11 222 460, tricyclic unsaturated compounds are reacted with a lightly acid-modified polymethacrylate. These groups can be eliminated by employing high-energy radiation after an operation to process the polymer in which the acid groups would be troublesome. However, for various reasons, the applicability of this process is restricted to few fields, for example laser lithography. In addition, the functional groups are attached exclusively by polymer-analogous methods.

A good overview of other groups which are removable by employing high-energy radiation and form acids as a cleavage product can be found in JP 2000 347 410. This comprises five types of alcohols which are esterified with methacrylic acid before the polymerization: monocyclic, heterocyclic, higher polycyclic, for example di- or tricyclic, groups, ethers which have a C1 bridge to the ester group, and compounds which are esterified via a tertiary alcohol. The latter group includes exclusively pure alkyl- or halogen-substituted alkyl groups. These methacrylates can be copolymerized with other methacrylates. For all compounds, exclusively activations by means of high-energy radiation after the polymerization are described, and not by means of thermal treatment.

Further groups convertible to acids with elimination, which can be incorporated together with tricyclic groups into polymethacrylates for applications in laser lithography, are described in JP 11 024 274. For this purpose, among others, the following type of monomers which are not specified in any further detail can be copolymerized:

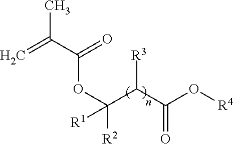

In this structure, n=0 or 1, and the R¹⁻³ radicals are hydrogen, standard alkyl radicals or the like, without any further specification of the groups. R⁴ is used only as a C1, C2 or C3 radical. These units are activated again only by means of high-energy radiation and therefore only at the surface, appropriately for the application of laser lithography. Problems are, as in the above-described examples, the by-products which remain in the product in a troublesome manner or have to be removed in a costly and inconvenient manner. The latter is completely impossible or at best possible only at the surface in the case of a radiative activation carried out after the processing. Furthermore, a process for synthesizing these units is not specified.

In Kricheldorf et al. (J. Pol. Sci.: Part A: Pol. Chem., 46, p. 6229-6237, 2008), substances of the

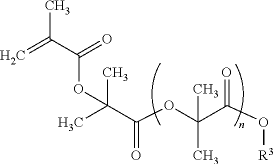

form are detected as a by-product of a polycondensation of α-hydroxyisobutyric acid anhydrosulphite to polyhydroxyisobutyric acid. However, these substances are neither isolated nor subjected to a polymerization of the methacrylate. Furthermore, the substances where R³=methyl or benzoyl detected in this reference are entirely unsuitable as a monomer owing to the high degree of condensation with an n of at least 20.

### PROBLEM

It is an object of the present invention to provide novel, thermally activable monomers. It is a further object to provide monomers which are copolymerizable in a simple manner with poly(meth)acrylates and can be incorporated, for example, into PMMA moulding materials.

It is a further object to provide a process for preparing monomers which can be used in various ways, in different functions.

One aspect is to provide monomers which enable the enhancement of the heat distortion resistance of moulding materials.

Another aspect is to provide monomers which improve the adhesion properties of film-forming binders, especially with respect to metal surfaces.

A third aspect is to provide monomers which are suitable for providing poly(meth)acrylates with particularly high acid numbers via a polymerization process which is not suitable per se for that purpose, such as solution polymerization in nonpolar solvents or ATRP (atom transfer polymerization).

Further objects which are not stated explicitly are evident from the overall context of the description, claims and examples which follow.

### SOLUTION

The objects are achieved by a novel process for preparing novel functional monomers based on (meth)acrylate. More particularly, the process relates to the synthesis of a monomer (I) of the general formula

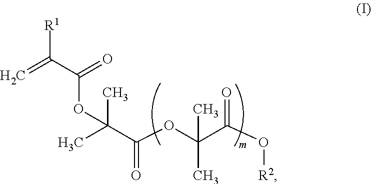

where R¹ is hydrogen or a methyl group, R² is hydrogen or an alkyl group consisting of 1 to 10 carbon atoms, and m is from 0 to 10, preferably from 0 to 5, more preferably from 0 to 2. Since the product of the process according to the invention may also be a mixture of different monomers (I), m may simultaneously and independently be present with several values within this range.

R² may have a linear, branched or cyclic structure. R² is preferably a simple alkyl group such as tert-butyl, n-butyl, isopropyl, propyl, ethyl or methyl. It is most preferably a methyl group and therefore, overall, α-hydroxyisobutyric acid methyl ester(meth)acrylate. Alternatively, R² may also be aromatics having 6 to 10 carbon atoms, such as a phenyl or benzyl group.

The novel monomer from the process according to the invention is obtained from (meth)acrylates or (meth)acrylic acid and α-hydroxyisobutyric acid or an alkyl α-hydroxyisobutyrate. More specifically, the monomer can be obtained by transesterification from a (meth)acrylate or by esterification from (meth)acrylic acid.

The notation “(meth)acrylate” represents esters of acrylic acid or of methacrylic acid. (Meth)acrylic acid correspondingly represents acrylic acid or methacrylic acid.

The monomer prepared in accordance with the invention is obtained as a mixture of several monomers (I). These differ in the degree of condensation, i.e. the number m. Overall, this mixture, after the synthesis and before the workup, has a proportion of the monomers (I) of at least 40% by weight, preferably of at least 55% by weight.

Alternatively, the monomer mixture can be purified by distillation after the synthesis step, in order either to increase the proportion of the monomers (I), or to isolate individual monomer species in which, for example, m may be from 0 to 2. Such a distillate has a proportion of monomers (I) of at least 70% by weight, preferably at least 90% by weight. The proportion can be enhanced by additional distillations or use of multistage distillation columns.

In this way, for example, monomer (II) where m=0 or monomer (III) where m=1 is obtainable.

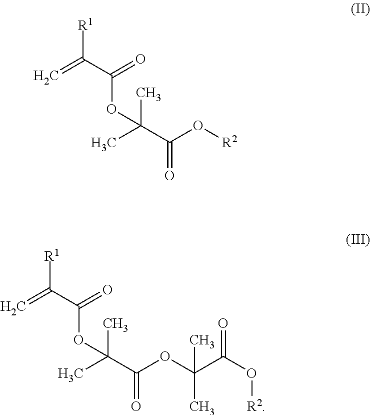

The synthesis or the isolation of the monomers (II) and (III) is novel, as is likewise the synthesis of monomers (I) where R¹═H, i.e. acrylates or monomers (I) having an R² radical which consists of not more than 10 carbon atoms.

Particular preference is given to methacrylic esters of methyl α-hydroxyisobutyrate, i.e. monomers (IIa) or (IIIa), where R¹ and R² are each a methyl group.

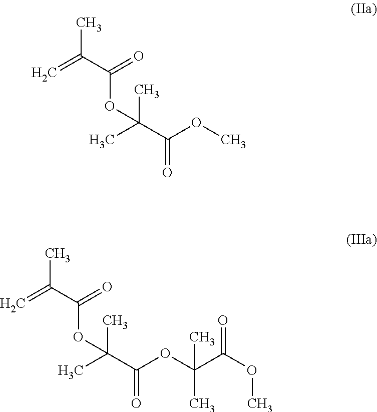

The monomers prepared in accordance with the invention, especially the monomers (I) with an R² radical consisting of 1 to 10 carbon atoms, preferably of 1 to 3 carbon atoms, and most preferably the monomers (II) or (III), are usable for the purpose of preparing polymers with a high acid content. For this purpose, the monomer is copolymerized with other monomers in a polymerization process to give a polymer with ester side groups. Then a substance (V) of the formula

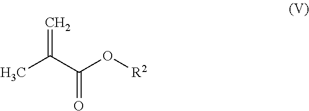

is eliminated in a polymer-analogous manner by supplying heat. In this way, acid groups are formed on the polymer. Since the inventive monomer contains ester groups obtained by the esterification of tertiary OH functions, these ester groups are eliminated more easily than the ester functions of the comonomers optionally used in addition.

This process is usable in various ways. For instance, the polymer may be a heat distortion-resistant moulding material. For this purpose, the polymer-analogous elimination of the substance (V) is preferably effected in an extruder or kneader. In this extruder or kneader, it is also possible to remove the residual monomers and/or the released substance (V) remaining. In the case that monomer (I) is α-hydroxyisobutyric acid methyl ester(meth)acrylate, methyl methacrylate (MMA) is released in the inventive thermal elimination.

Repeat units resulting from (meth)acrylic acid units, preferably from methacrylic acid units, contribute to significantly improved heat distortion resistance of moulding materials and the mouldings produced from these moulding materials. The glass transition temperature rises with the acid content, and hence the heat distortion resistance of the moulding material.

It is a particular feature of the process according to the invention that substance (V) is methacrylic acid or an ester of methacrylic acid. The advantage of the release of such compounds, which are analogous or even identical to the monomers used beforehand to prepare the moulding material, is that, after release, they are incorporated either into existing or new polymer chains, or else are removed by distillation from the system together with the residual monomers and, in contrast to other elimination products, can be used again for the monomer synthesis or for the polymer preparation.

For preparation of the inventive monomers (I), in addition to an esterification, other preferred options are a transesterification, for example of MMA or tert-butyl(meth)acrylate, or the reaction with an acid halide such as (meth)acryloyl chloride or the reaction with (meth)acrylic anhydride. It has been found that, surprisingly, the catalysts used for this purpose, when they remain in the product, promote the hydrolysis of the ester side groups of the polymer in the elimination reaction at relatively high temperatures. For this purpose, such transesterification catalysts can also be added to the polymers containing the monomers prepared in accordance with the invention before the supply of heat. The polymer-analogous elimination of the substance (V) can thus optionally be accelerated by addition or presence of a transesterification catalyst.

The transterification catalysts used may be a.) Brønsted acids, for example sulphuric acid, para-toluenesulphonic acid, acidic ion exchangers or a combination thereof with metals such as zinc oxide; b.) bases, such as especially metal alkoxides, especially alkoxides of lithium, of sodium or of potassium, such as LiOCH₃, NaOCH₃, KOCH₃, the corresponding acetates, propionates or butoxides; but also aluminium compounds such as aluminium isopropoxide; carbonates such as K₂CO₃; hydroxides such as LiOH, NaOH, Ca(OH)₂; basic oxides such as CaO; basic ion exchangers; ammonia; metal amides such as LiNH₂ or NaNH₂; amines such as primary, secondary or tertiary amines, such as triethylamine, diisopropylethylamine; or particularly strong amines such as 4-(dimethylamino)pyridine (DMAP) or 1,8-diazabicyclo[5.4.0]undec-7-ene (DBU; should be used together with LiBr); and c.) Lewis acids or metal oxides, especially titanium catalysts, zirconium catalysts or tin catalysts, such as isopropyl titanate, isobutyl titanate, titanium hydroxide, titanium dioxide, dioctyltin oxide, dibutyltin oxide, tributyltin alkoxides, dibutyltin dialkoxides; dibutyltin dichloride; titanium tetraalkoxides, titanium tetrachloride or mixed forms, such as Ti(OEt)₄, Ti(OEt)₄₋ₙ(OMe)ₙ, Ti(Oi-Pr)₃Cl or Ti(Oi-Pr)₂Cl₂; but also other metal compounds such as i-PrOCu(PPh)₃, palladium catalysts. Alternatively, it is also possible to use enzymes suitable for this purpose for transesterification. A good overview of a variety of usable transesterification catalysts and methods for transesterification can be found in Otera (Chem. Rev., 93, 1993, p. 1449-70).

Preference is given to using bases, particular preference to using metal alkoxides and very particular preference to using methoxides, ethoxides, propionates, isopropionates, butoxides or isobutoxides of lithium, of sodium or of potassium as transesterification catalysts.

To improve the yield, it is additionally possible to use further assistants, such as molecular sieves. It is also possible to distillatively remove the alcohols released during the transesterification reaction.

In addition, this process, however, is also usable in other fields of polymer chemistry. For instance, according to the prior art, poly(meth)acrylates with a high acid content can be prepared only with very great difficulty, if at all, by means of a solution polymerization, especially in organic or even nonpolar solvents. In contrast, an optionally catalysed thermal aftertreatment does indeed make it possible, with the process according to the invention, also to use these polymerization methods for synthesis of poly(meth)acrylates with a high acid number.

This aspect is of significance especially in respect of a controlled free-radical polymerization, with the aid of which polymer architectures such as block, star or graft copolymers are prepared, for example in the form of amphiphilic block copolymers as used in membrane technology. Examples of such polymerization methods are NMP (Nitroxide-Mediated Polymerization) and RAFT (Reversible Addition-Fragmentation Chain Transfer Polymerization).

The process according to the invention has additional significance in the case of use of an anionic polymerization or of a further controlled free-radical polymerization process, ATRP (Atom Transfer Radical Polymerization), neither of which is performable in the presence of acids owing to deactivation of the initiators or catalysts.

The process according to the invention also has great significance with regard to the preparation of monomers (IV).

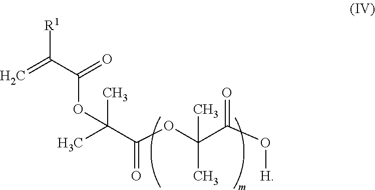

The monomers (IV) are notable especially in that there is a longer bridge between the (meth)acryloyl group or—after the polymerization—the polymer chain and the acid group, compared to (meth)acrylic acid. This is referred to as a spaced-apart acid. It has been found in terms of performance that such acids contribute better to adhesion to substrates such as metals in particular, compared to (meth)acrylic acid. This has advantages especially in the production of a film-forming binder. The thermal stability of the (co)polymers prepared from the monomers (IV) is sufficient for such a coatings application, in which the curing is generally effected at room temperature.

Monomers of the formulae (I), (II), (III) and (IV) can also be used as comonomers. In particular, copolymerization with (meth)acrylates and/or with monomers copolymerizable with (meth)acrylates is one possible use of the monomers prepared in accordance with the invention.

The inventive monomers can be copolymerized to prepare polymers, such as moulding materials or film-forming binders, with a series of monomers. For example, it is possible to use methyl(meth)acrylate, ethyl(meth)acrylate, propyl(meth)acrylate, isopropyl(meth)acrylate, butyl(meth)acrylate, isobutyl(meth)acrylate, tert-butyl(meth)acrylate, hexyl(meth)acrylate, heptyl(meth)acrylate, 2-ethylhexyl(meth)acrylate, cyclohexyl(meth)acrylate, octyl(meth)acrylate, isooctyl(meth)acrylate, decyl(meth)acrylate, benzyl(meth)acrylate, tetrahydrofurfuryl(meth)acrylate, octadecyl(meth)acrylate, dodecyl(meth)acrylate, tetradecyl(meth)acrylate, oleyl(meth)acrylate, 4-methylphenyl(meth)acrylate, benzyl(meth)acrylate, furfuryl(meth)acrylate, cetyl(meth)acrylate, 2-phenylethyl(meth)acrylate, isobornyl(meth)acrylate, neopentyl(meth)acrylate, vinyl methacrylate, hydroxyethyl methacrylate, methacrylamide, n-isopropylmethacrylamide or mixtures of two or more of the monomers listed.

In addition to the (meth)acrylates listed, the polymers may also be formed from other monomers which are not based on (meth)acrylic acid but are copolymerizable therewith. Examples thereof are styrene, α-methylstyrene, norbornene, cyclohexylmaleimide, itaconic acid or maleic anhydride.

Both lists, both that of the (meth)acrylates and that of the monomers copolymerizable with (meth)acrylates, are illustrative and are in no way capable of restricting the present invention in any way.

### EXAMPLES

### Example 1

### Monomer Synthesis

A mixture of 885.8 g of methyl α-hydroxyisobutyrate (MHIB), 1876.9 g of methyl methacrylate (MMA, from Evonik Röhm), 0.349 g of hydroquinone monomethyl ether (from Merck) and 0.014 g of 4-hydroxy-2,2,6,6-tetramethylpiperidine 1-oxyl (TEMPOL, from Evonik Degussa) is initially charged in a 4 1 four-neck flask with sabre stirrer (stirrer sleeve, stirrer motor), a thermometer, an inlet tube for compressed air, a silver mirror column (consisting of 8*8 Raschig rings and an automatic column head), a jacketed coil condenser, distillation condenser, a Anschütz-Thiele receiver, an oil bath with temperature regulation and a vacuum pump (with cold traps). The mixture is heated to boiling, and water obtained in the course thereof is removed azeotropically.

After cooling to 80° C., the catalyst (27.93 g of sodium methoxide solution, 30% by weight in methanol, from Evonik Degussa) is added. Subsequently, the mixture is refluxed at an oil bath temperature of approx. 130° C. for 15 h. The flask interior temperature is between 105° C. and 108° C. for the whole time.

Finally, at the same external temperature, volatile constituents are removed under reduced pressure. The crude product obtained after a filtration is 741.9 g of a turbid, brown, slightly viscous liquid.

TABLE 1
Compositions of the crude product by GC (in area %)

| | Filtered |
|---|---|
| Product/impurity | product |
| Methanol | 0.43 |
| MMA | 2.01 |
| Methacrylic acid (MAA) | 4.79 |
| Further constituents | 10.48 |
| Unidentified | 2.50 |
| MHIB | 4.94 |
| HIBA-MHIB | 6.37 |
| HIBA-HIBA-MHIB | 3.76 |
| MHIB + MMA | 0.91 |
| HIBM-MA + MAA | 0.96 |
| Monomer (IIa) | 46.27 |
| Monomer (IIIa) | 16.58 |

Further abbreviations:
HIBA-MHIB Ester formed from α-hydroxyisobutyric acid (HIBA) and MHIB
HIBA-HIBA-MHIB Ester formed from HIBA and HIBA-MHIB
MHIB + MMA Addition product of MMA onto the hydroxyl group of MHIB
HIBM-MA + MAA Addition product of MAA onto the OH group of HIBM-MA

### Example 2

### Distillation of the Crude Product from Example 1)

A 1 l three-neck flask with sabre stirrer (stirrer sleeve, stirrer motor), boiling capillary, thermometer, silver mirror column (20 cm, 6 mm Raschig rings), distillate thermometer, distillation system, Anschütz-Thiele receiver, oil bath with temperature regulation, cold traps, manometer and oil-driven rotary vane vacuum pump is initially charged with 668.0 g of the crude product from Example 1 with 0.334 g of hydroquinone monomethyl ether (from Merck), 0.013 g of TEMPOL and 70.0 g of the Malotherm SH heat transfer reagent (from Sasol). The mixture is fractionally distilled under reduced pressure; see the distillation process in Table 2.

All fractions are clear colourless liquids. In fractins F and G, white crystals form after a few hours. The distillation residue is a brown, turbid liquid.

Fractions B and C show that monomer (IIa) is obtained with one distillation in a purity of more than 88 area (GC, also corresponds roughly to the proportion by mass). Fraction G shows that monomer (IIIa) can also be obtained in a content of more than 50 area %.

In addition, it is evident that the total content of inventive monomers in fractions B and C is more than 90 area %, that in fraction D is more than 85 area % and that in fractions A and E is more than 70 area %. Thus, it is already possible to obtain monomers in high purities, without troublesome constituents such as MAA, with only one nonoptimized distillation.

TABLE 2
Distillation process

| Fraction | A | B | C | D | E | F | G |
|---|---|---|---|---|---|---|---|
| Weight | 76.6 g | 64.2 g | 52.6 g | 91.2 g | 76.9 g | 53.8 g | 96.0 g |
| Bottom temp. [° C.] | 63-96 | 96-101 | 101-103 | 103-108 | 108-113 | 113-145 | 145-166 |
| Distillate temp. [° C.] | 30-65 | 65-75 | 75-78 | 74-78 | 64-74 | 64-97 | 97-102 |
| Pressure [mbar] | 0.41-0.44 | 0.41-0.58 | 0.58-0.74 | 0.74-0.94 | 0.53-0.94 | 0.53-0.55 | 0.55-2.50 |
| Collection time [min] | 15 | 6 | 7 | 12 | 28 | 12 | 23 |
| Methanol [area %] | — | 0.01 | — | 0.01 | — | — | — |
| MMA [area %] | 1.82 | 0.05 | — | — | — | — | 0.01 |
| MAA [area %] | — | — | — | — | — | — | — |
| Further constituents [area %] | 2.60 | 1.96 | 2.58 | 5.77 | 14.09 | 14.67 | 21.34 |
| Unidentified [area %] | 0.41 | 0.32 | 0.32 | 0.27 | 0.42 | 1.34 | 6.66 |
| MHIB [area %] | 21.03 | 3.25 | 0.85 | 0.69 | 2.00 | 4.45 | 2.58 |
| HIBA-MHIB [area %] | 2.48 | 3.97 | 4.65 | 5.74 | 8.54 | 27.55 | 9.36 |
| HIBA-HIBA-MHIB [area %] | 0.01 | 0.14 | 0.25 | 0.42 | 0.64 | 2.54 | 3.14 |
| MHIB + MMA [area %] | 0.01 | 0.01 | 0.02 | 0.03 | 0.07 | 0.12 | — |
| HIBM-MA + MAA [area %] | — | — | — | — | — | 0.01 | 0.03 |
| Monomer (IIa) [area %] | 71.07 | 88.38 | 88.38 | 81.91 | 62.91 | 5.71 | 0.57 |
| Monomer (IIIa) [area %] | 0.57 | 1.97 | 2.95 | 5.17 | 11.33 | 43.68 | 56.32 |

1. A process comprising:
(a) copolymerizing at least one monomer selected from the group consisting of a monomer of formula (II) and a monomer of formula (III): 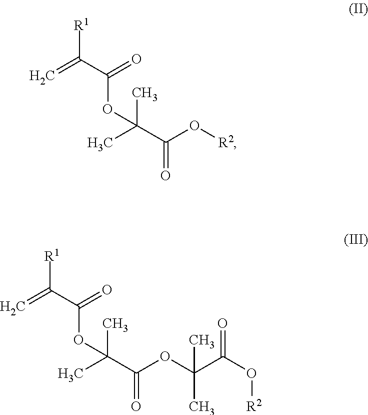
with at least one other monomer, to obtain a first polymer; and
(b) eliminating a compound of formula (V) then a substance (V) of the formula 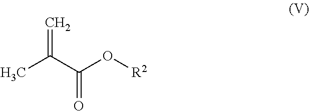
from the first polymer in a polymer-analogous manner by supplying heat, to obtain a second polymer comprising an acid group,
wherein R¹ is hydrogen or a methyl group, and R² is an alkyl group having 1 to 10 carbon atoms.

2. The process of claim 1, wherein the eliminating is performed in an extruder or kneader.

3. The process of claim 1, wherein the eliminating is accelerated by addition or presence of a transesterification catalyst.

4. The process of claim 1, wherein the copolymerizing is an anionic or controlled free-radical polymerization.

5. The process of claim 1, wherein R¹ is hydrogen.

6. The process of claim 1, wherein R¹ is a methyl group.

7. The process of claim 1, wherein R² is a methyl group.

8. The process of claim 1, wherein R² is a tert-butyl group.

9. The process of claim 1, wherein R² is an n-butyl group.

10. The process of claim 1, wherein R² is an isopropyl group.

11. The process of claim 1, wherein R² is a propyl group.

12. The process of claim 1, wherein R² is an ethyl group.

13. The process of claim 1, wherein both R¹ and R² are methyl groups.

14. The process of claim 1, wherein the other monomer is a (meth)acrylate, a monomer copolymerizable with a (meth)acrylate, or both.

15. The process of claim 1, wherein the other monomer is at least one selected from the group consisting of: methyl(meth)acrylate, ethyl(meth)acrylate, propyl(meth)acrylate, isopropyl(meth)acrylate, butyl(meth)acrylate, isobutyl(meth)acrylate, tert-butyl(meth)acrylate, hexyl(meth)acrylate, heptyl(meth)acrylate, 2-ethylhexyl(meth)acrylate, cyclohexyl(meth)acrylate, octyl(meth)acrylate, isooctyl(meth)acrylate, decyl(meth)acrylate, benzyl(meth)acrylate, tetrahydrofurfuryl(meth)acrylate, octadecyl(meth)acrylate, dodecyl(meth)acrylate, tetradecyl(meth)acrylate, oleyl(meth)acrylate, 4-methylphenyl(meth)acrylate, benzyl(meth)acrylate, furfuryl(meth)acrylate, cetyl(meth)acrylate, 2-phenylethyl(meth)acrylate, isobornyl(meth)acrylate, neopentyl(meth)acrylate, vinyl methacrylate, hydroxyethyl methacrylate, methacrylamide, and n-isopropylmethacrylamide.

16. The process of claim 1, wherein the other monomer is at least one selected from the group consisting of: styrene, α-methylstyrene, norbornene, cyclohexylmaleimide, itaconic acid, and maleic anhydride.

17. The process of claim 1, wherein the other monomer is methyl methacrylate.

18. The process of claim 3, wherein the transesterification catalyst is a Brønsted acid, a Lewis acid, or an enzyme.

19. The process of claim 3, wherein the transesterification catalyst is an alkali metal alkoxide.

20. The process of claim 19, wherein the metal is lithium, sodium or potassium, and the alkoxide is selected from the group consisting of methoxide, ethoxide, propionate, isopropionate, butoxide, and isobutoxide.
